(19) United States
(12) Patent Application Publication
(10) Pub. No.: US 2010/0131889 A1
(43) Pub. Date: May 27, 2010

(54) USER INTERFACE TO EXPLORE DATA OBJECTS AND THEIR RELATED SUPPLEMENTARY DATA OBJECTS

(76) Inventors: Hans-Ulrich HELMOLT, Heidelberg (DE); Renato ZADRO, Bruchl (DE); Jan POESCHEL, Angelbachtal (DE)

Correspondence Address: SAP AG, 3410 HILLVIEW AVENUE, PALO ALTO, CA, 94304, US

(21) Appl. No.: 12/276,295

(22) Filed: Nov. 21, 2008

(51) Int. Cl. G06F 3/048; G06F 17/30; G06F 7/00

(52) U.S. Cl. 715/804; 707/E17.014; 707/E17.044

(57) ABSTRACT

Disclosed is a user interface for interactively exploring data objects associated with a business context. The user interface includes a business data explorer having an object navigation panel and a side panel. The object navigation panel is operable for displaying a first one of the data objects as a data object of current interest to a user for further exploration. The side panel is operable for displaying a second one of the data objects as a supplementary data object, based at least in part on the business context defined at least in part by an application having the data objects. The business data explorer is operable for displaying the second one of the data objects in the object navigation panel as the data object of current interest to the user for further exploration and in response to a second user selection of a portion of the second one of the data objects, presenting at least one additional supplementary data object based at least in part on the business context defined by the user selected portion of the second one of the data objects.

### FIELD OF THE INVENTION

The invention generally relates to the field of computer generated user interfaces. More particularly the invention relates to an user interface for exploring data objects and their related supplementary data objects.

### BACKGROUND OF THE INVENTION

The user interfaces currently available typically do not allow a user to explore data objects in an intuitive way. The amount of information presented to the user is also limited to immediate context of the data object being presented. If the user wishes to explore the data objects further, he may have to leave his current use context to log on to a different application or a system or another user interface to access other information related to the data object he is currently viewing. For example, conventional user interfaces are limited to displaying customer information such as a customer name, address, contact person, customer identification, and sales orders related to the customer. If the user wishes to explore further details such as details of each of the sales order of the customer or the materials in the sales order, the user has to typically log into a different application or refer to another user interface to see the details. This is not very convenient because the user may have to switch between various user interfaces to comprehend all the details of a particular data object, and in that process, may lose the context of the information. The user may face this problem often since the contextual information of a data object is typically not presented in a single user interface.

### SUMMARY OF THE INVENTION

Described herein is a user interface for interactively exploring data objects associated with a business context. The user interface includes a business data explorer having an object navigation panel and a side panel. The object navigation panel is operable for displaying a first one of the data objects as a data object of current interest to a user for further exploration. The side panel is operable for displaying a second one of the data objects as a supplementary data object, based at least in part on the business context defined at least in part by an application having the data objects. The business data explorer is operable for displaying the second one of the data objects in the object navigation panel as the data object of current interest to the user for further exploration and in response to a second user selection of a portion of the second one of the data objects, presenting at least one additional supplementary data object based at least in part on the business context defined by the user selected portion of the second one of the data objects.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is an example screen display of a business data explorer to display a first data object of current interest in an object navigation panel and a second data object as a supplementary data object in a side panel of the business data explorer according to an embodiment of the invention.

FIG. 2 is an exemplary screen display of the business data explorer of FIG. 1 for exploring a user selected supplementary data object according to an embodiment of the invention.

FIG. 3 is an exemplary screen display of the business data explorer of FIG. 2 for displaying a list of additional supplementary data objects based on a business context defined by a user selected portion of the supplementary data object according to an embodiment of the invention.

FIG. 4 is an exemplary screen display of the business data explorer for displaying an additional supplementary data object which is selected from the list of additional supplementary data objects of FIG. 3 according to an embodiment of the invention.

FIG. 5 is an exemplary screen display of a query view in the side panel to view and search for additional supplementary data objects based on a keyword according to an embodiment of the invention.

FIG. 6 is an exemplary screen display of a dashboard view in the business data explorer according to an embodiment of the invention.

FIG. 7 is a block diagram of a system for displaying the business data explorer user interface panel according to an embodiment of the invention.

### DETAILED DESCRIPTION

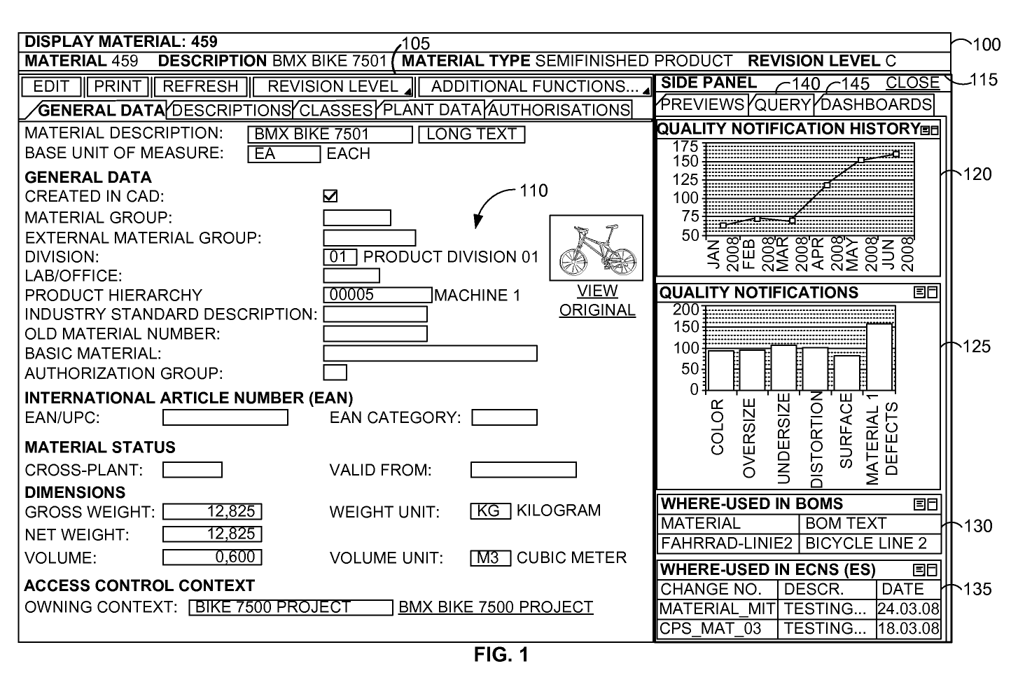

FIG. 1 is an example screen display of an user interface panel of a business data explorer 100 operable for displaying a first data object 110 of current interest in an object navigation panel 105 and a second data object as a supplementary data object in a side panel 115 of the business data explorer 100 according to an embodiment of the invention. The object navigation panel 105 displays a first data object 110 that is of current interest to the user. The side panel 115 displays one or more supplementary data objects that are related to the first data object 110 based on a business context of the application. The business context is defined by the application. In one embodiment, a data object is any data entity that represents information about another entity. The data objects could include but are not limited to, records in a data base, data tables, data fields, analytics, business objects, charts, images, textual description, etc.

For example, in a product lifecycle management application when a user is exploring a material object 110, the supplementary data objects related to the material object 110 include, but are not limited to, a list of customers to whom the material object 110 is sold, analytics about the history of the quality notifications received for the material object 110, various quality notifications received for the material object 110, a bill of material in which the material object 110 is used, a list of changes made to the material object 110, and a list of customers to whom the material object 110 is sold. All or a subset of the supplementary data objects are displayed in the side panel 115.

As illustrated in the business data explorer 100, the material object 110, which is the object of current interest to the user, is presented in the object navigation panel 105. The object navigation panel 105 presents details of material object 110 such as a material number, material name, material description, a picture of a material, a unit of measure, and dimensions of the material. The side panel 115 presents the supplementary data objects such as analytics about the quality notifications history 120 for the material object 110, quality notifications 125 received for the material object 110, a bill of materials 130 in which the material object 110 is used, and a list of changes 135 done to the material object 110.

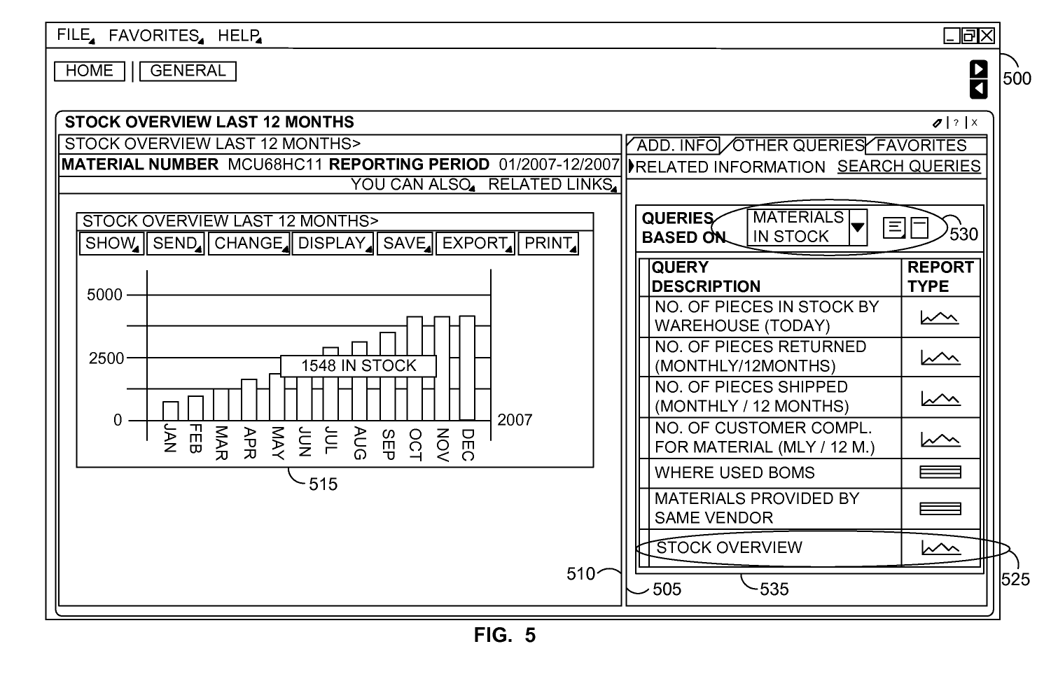

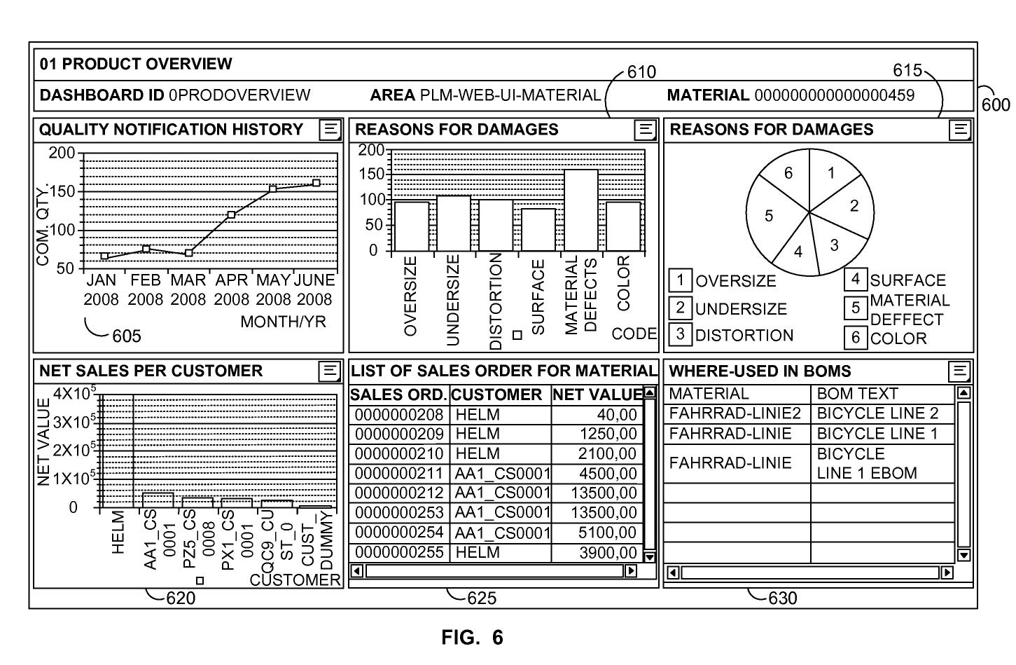

The supplementary data objects may be displayed in various formats that include but are not limited to, a chart, a picture, a table and a text. For example, the quality notifications history 120 is displayed as a line chart and the bill of materials 130 in which the material object 110 is used is displayed as a table in the side panel 115. Furthermore, the display of each of the supplementary data objects may be customized. The customization options include but are not limited to, changing the order in which the supplementary data objects are displayed, changing a format, minimizing, hiding, adding, and removing the supplementary data objects. Furthermore, the business data explorer 100 may be configured to change position of the side panel 115 on either left side or right side of the business data explorer 100. The side panel also has a query view 140 and a dashboard view 145 that display various additional supplementary data objects as explained further below with reference to FIG. 5 and FIG. 6.

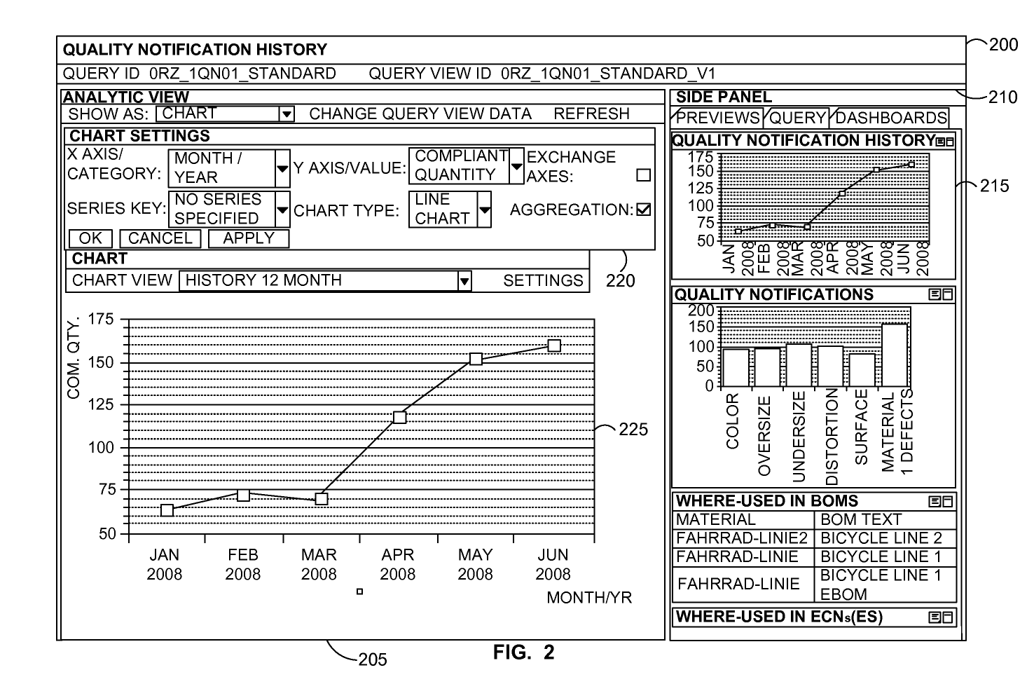

FIG. 2 is an exemplary screen display of the business data explorer of FIG. 1 for exploring a user selected supplementary data object according to an embodiment of the invention. The business data explorer 200 allows the user to further explore any of the supplementary data objects displayed in side panel 210. The user may further explore the supplementary data object in the side panel 210 by bringing it to the object navigation panel 205. For example, the supplementary data object, quality notification history 215, may be brought to the object navigation panel 205 by user actions such as dragging or double clicking the quality notification history 215 chart.

The quality notification history 225 displayed in the object navigation panel 205 may be further explored in various ways using data object settings 220. For example, format of quality notification history 225 may be changed from chart to any other format such as a table, the chart type may be changed to a bar chart, the X-axis and Y-axis values may be changed and the X-axis and Y-axis may be swapped. In an embodiment, the X-axis of the chart which is scaled on Month/Year basis may be scaled down to Week/Month or Day/Week to explore the quality notifications received on a daily or weekly basis. Similarly, the X-axis may also be scaled up to Quarter/Year or Half/Year. In another embodiment, the Y-axis value may be changed from Complaint quantity to say, for example, average time taken to solve the complaint. Furthermore, the period for which the quality notifications are shown may also be changed.

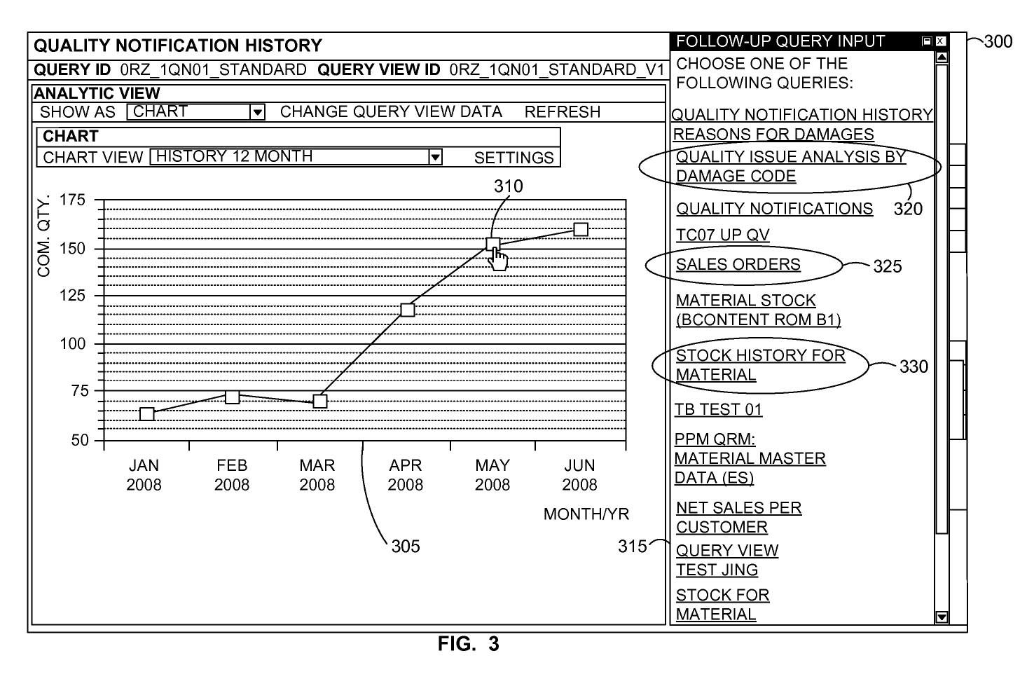

FIG. 3 is an exemplary screen display of the business data explorer of FIG. 2 for displaying a list of additional supplementary data objects based on a business context defined by a user selected portion of the supplementary data object according to an embodiment of the invention. The user may further explore the supplementary data object by selecting a portion of the supplementary data object and fetching a list of additional supplementary data objects that are related to the supplementary data object based on a business context of the application and the selected portion of the supplementary data object.

For example, the user may select a data point 310 on the quality notification history 305 chart and obtain a list of queries 315 that in turn is operable for obtaining additional supplementary objects related to the chosen data point 310. In an embodiment, the list of queries 315 is generated in the business data explorer 300 when the data point 310 is selected via a mouse click. Queries in the list of queries 315 are related to the data point 310 based on a business context of the data point 310. In one embodiment, the business context can be determined my matching the attributes of the data point 310 with queries that take data values of these attributes as input. For example, attributes of the data point 310 such as a material number of material object 110, an X co-ordinate and Y co-ordinate attribute names (e.g., quantity of complaints and months, respectively) are used to find queries that take these attributes as input. After the list of queries 315 is generated, the user may choose a query from the list of queries 315 to obtain the additional supplementary data object that is related to the data point 310. On choosing the query, the additional supplementary data object is displayed in the business data explorer.

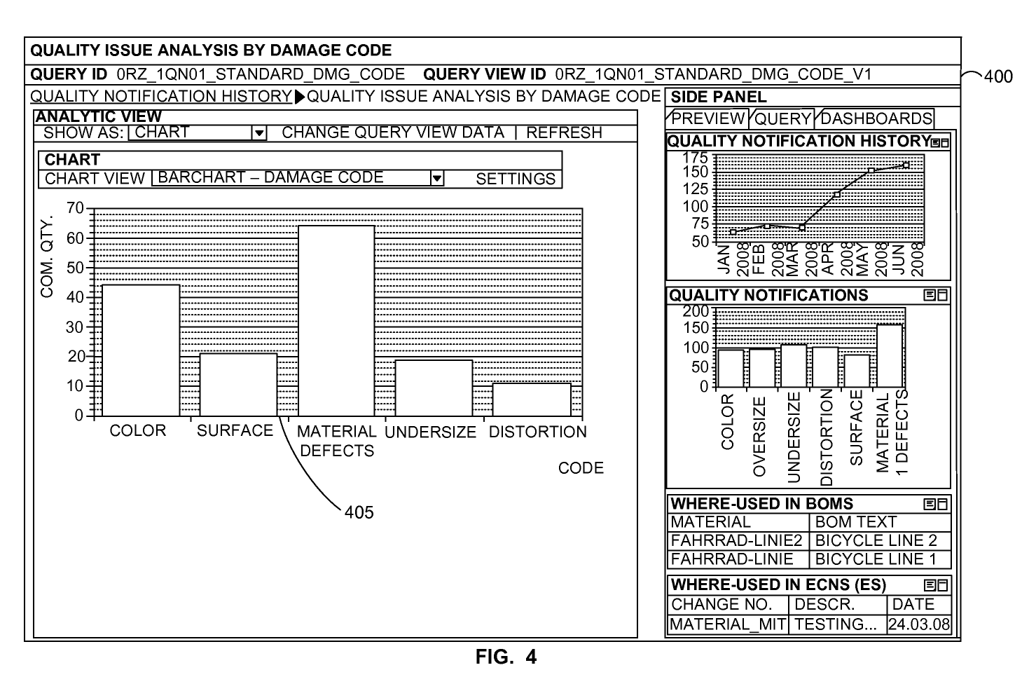

For example, on choosing a query “Quality Issue Analysis by Damage Code” 320, the business data explorer 400 presents the additional supplementary data object 405 that displays all damages reported for the material in the month “May 2008” as illustrated in FIG. 4. Similarly, the list of queries 315 contains queries such as “Sales Orders” 325 that displays a list of sales orders for that material in “May 2008” and “Stock History for Material” 330 that displays stock history of the material in “May 2008”.

The business data explorer as explained in figures FIG. 1, FIG. 2, FIG. 3 and FIG. 4 enables a user to explore a data object and various supplementary data objects that are related to the data object by coordinating the navigation through a single user interface panel. The business data explorer obtains the supplementary data objects from various systems and presents them in a single user interface without requiring the user to leave their current user interface context.

FIG. 5 is an exemplary screen display of a query view in the side panel to view and search for additional supplementary data objects based on a keyword according to an embodiment of the invention. The query view 520 in the side panel 505 allows the user to search for additional supplementary data objects related to the data object displayed in the object navigation panel 510. For example, the user may search for stock information of the material object 110 by entering a search keyword “Materials in Stock” 530 in the query view 520. Query list 535 displays additional supplementary objects having stock related information of the material object 110. The user may choose a query from the query list 535 to display the additional supplementary object in the object navigation panel 510. For example, the query “Stock Overview” 525 displays additional supplementary data object, “Stock Overview last 12 months” 515 in object navigation panel 510 of business data explorer 500.

In an embodiment, the query view 520 retrieves a list of all available supplementary data objects that are related to the material object 110 if no keyword is entered in the query view.

FIG. 6 is an exemplary screen display of a dashboard view in the business data explorer of FIG. 1 according to an embodiment of the invention. The user may switch to dashboard view 600 by clicking the tab dashboard 145 in the side panel 115. The user gets a comprehensive view of various supplementary data objects related to the material object 110 in the dashboard view 600. For example, dashboard view 600 displays additional supplementary data objects such as quality notification history 605, reasons for damages as a bar chart 610, reasons for damages as a pie chart 615, a net sales per customer 620, list of sales orders for material 625, and where-used in BOMs 630.

Further the user may customize the dashboard view 600 in various ways that include but are not limited to, changing an order of displaying the additional supplementary data objects, changing a format, minimizing, hiding, adding, and removing the additional supplementary data objects.

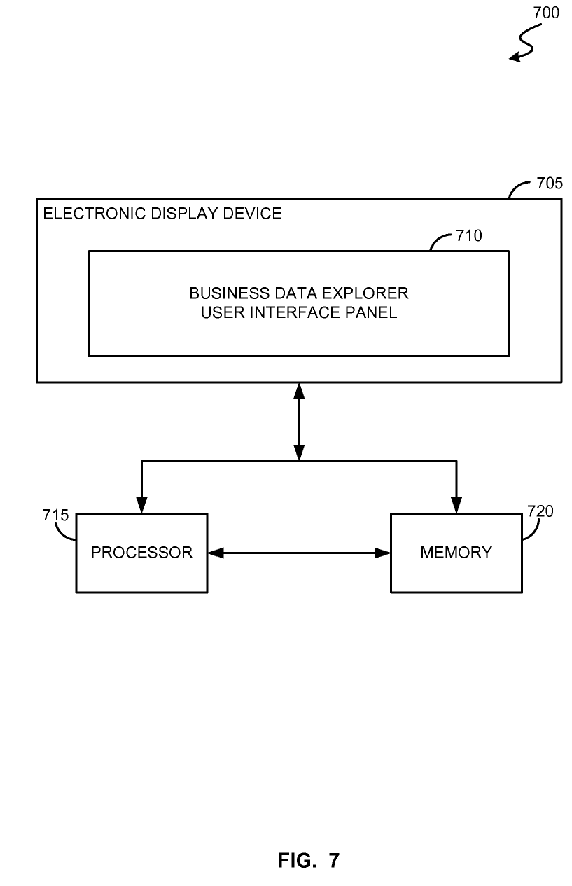

FIG. 7 is a block diagram of a system for displaying the business data explorer user interface panel according to an embodiment of the invention. System 700 includes a processor 715 that executes the instructions provided by memory 720 to generate the business data explorer user interface panel 710 in the electronic display device 705. The system 700 obtains data objects, supplementary data objects and additional supplementary data objects from one or more applications over a communication network. For example, in an enterprise business scenario, the data objects, the supplementary data objects and the additional supplementary data objects may be obtained from applications including but not limited to supply relationship management application, customer relationship management application, supply chain management application, product lifecycle management application and human resource management application.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or any other type of machine-readable media suitable for tangibly storing electronic instructions. The machine readable medium can provide the instructions stored therein to a computer system comprising a processor capable of reading and executing the instructions to implement the method steps described herein.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

What is claimed is:

1. A computer generated user interface operable for interactively exploring data objects associated with a business context, the user interface comprising:
a business data explorer user interface panel comprising an object navigation panel and a side panel;
the object navigation panel operable for displaying a first one of the data objects as a data object of current interest to a user for further exploration;
the side panel operable for displaying a second one of the data objects as a supplementary data object, based at least in part on the business context defined at least in part by the first one of the data objects;
the business data explorer operable for:
in response to a first user selection, displaying the second one of the data objects in the object navigation panel as the data object of current interest to the user for further exploration and displaying in the side panel a third one of the data objects as the supplementary data object, the third one of the data objects determined based at least in part on the business context defined by the second one of the data objects; and
in response to a second user selection of a portion of the second one of the data objects, presenting at least one additional supplementary data object to be chosen for displaying wherein the additional supplementary data object is presented as a choice based at least in part on the business context defined by the user selected portion of the second one of the data objects.

2. The user interface of claim 1, wherein the side panel further comprises a query view including a list of queries to obtain additional supplementary data objects, based at least in part on the business context defined at least in part by the application having the data objects.

3. The user interface of claim 1, wherein the side panel further comprises a search feature operable for searching for the additional supplementary objects based on a keyword.

4. The user interface of claim 1, wherein the side panel further comprises a dashboard view that displays the supplementary data objects and the additional supplementary data objects as analytics in a dashboard.

5. The user interface of claim 1, wherein the side panel further comprises a customization option selection menu comprising selection choices including one or more of, changing an order in which the supplementary data objects are displayed, changing a type of the supplementary data objects, adding a new supplementary data object, removing one of the supplementary data objects, changing a position of the side panel to left side and right side of the business data explorer user interface panel, and hiding the side panel.

6. The user interface of claim 1, wherein the business data explorer displays the supplementary data objects and additional supplementary data objects in a format selected from a group consisting of a chart, an image, a table, and a text.

7. The user interface of claim 1, wherein the user selected portion includes a data item selected from a group consisting of a co-ordinate in a chart, a row in table, a column in a table, a cell in a table, a line in a text, a word in a text, and a portion of an image.

8. An article of manufacture, comprising:
a machine readable medium having instructions stored thereon which when executed by a machine cause the machine to generate a user interface operable for interactively exploring data objects associated with a business context, the user interface comprising:
a business data explorer user interface panel comprising an object navigation panel and a side panel;
the object navigation panel operable for displaying a first one of the data objects as a data object of current interest to a user for further exploration;
the side panel operable for displaying a second one of the data objects as a supplementary data object, based at least in part on the business context defined at least in part by the first one of the data objects;
the business data explorer operable for:
in response to a first user selection, displaying the second one of the data objects in the object navigation panel as the data object of current interest to the user for further exploration and displaying in the side panel a third one of the data objects as the supplementary data object, the third one of the data objects determined based at least in part on the business context defined by the second one of the data objects; and
in response to a second user selection of a portion of the second one of the data objects, presenting at least one additional supplementary data object to be chosen for displaying wherein the additional supplementary data object is presented as a choice based at least in part on the business context defined by the user selected portion of the second one of the data objects.

9. The article of manufacture in claim 8, wherein the side panel further comprises a query view including a list of queries to obtain additional supplementary data objects, based at least in part on the business context defined at least in part by the application having the data objects.

10. The article of manufacture in claim 8, wherein the side panel further comprises a search feature operable for searching for the additional supplementary objects based on a keyword.

11. The article of manufacture in claim 8, wherein the side panel further comprises a dashboard view that displays the supplementary data objects and the additional supplementary data objects as analytics in a dashboard.

12. The article of manufacture in claim 8, wherein the side panel further comprises a customization option selection menu comprising selection choices including one or more of, changing an order in which the supplementary data objects are displayed, changing a type of the supplementary data objects, adding a new supplementary data object, removing one of the supplementary data objects, changing a position of the side panel to left side and right side of the business data explorer user interface panel, and hiding the side panel.

13. The article of manufacture in claim 8, wherein the business data explorer displays the supplementary data objects and additional supplementary data objects in a format selected from a group consisting of a chart, an image, a table, and a text.

14. The article of manufacture in claim 8, wherein the user selected portion includes a data item selected from a group consisting of a co-ordinate in a chart, a row in table, a column in a table, a cell in a table, a line in a text, a word in a text, and a portion of an image.

15. A computer system including a processor and a memory, the memory comprising instructions that are executable by the processor to generate a business data explorer user interface panel, the business data explorer comprising:
a business data explorer user interface panel comprising an object navigation panel and a side panel;
the object navigation panel operable for displaying a first one of the data objects as a data object of current interest to a user for further exploration;
the side panel operable for displaying a second one of the data objects as a supplementary data object, based at least in part on the business context defined at least in part by the first one of the data objects;
the business data explorer operable for:
in response to a first user selection, displaying the second one of the data objects in the object navigation panel as the data object of current interest to the user for further exploration and displaying in the side panel a third one of the data objects as the supplementary data object, the third one of the data objects determined based at least in part on the business context defined by the second one of the data objects; and
in response to a second user selection of a portion of the second one of the data objects, presenting at least one additional supplementary data object to be chosen for displaying wherein the additional supplementary data object is presented as a choice based at least in part on the business context defined by the user selected portion of the second one of the data objects.
